(19) United States
(12) Patent Application Publication
(10) Pub. No.: US 2011/0106476 A1
(43) Pub. Date: May 5, 2011

(54) METHODS AND SYSTEMS FOR THERMISTOR TEMPERATURE PROCESSING

(75) Inventors: YO CHAN SON, TORRANCE, CA (US); NITINKUMAR R. PATEL, CYPRESS, CA (US); JONATHAN H. FAIR, REDFORD, MI (US)

(73) Assignee: GM GLOBAL TECHNOLOGY OPERATIONS, INC., DETROIT, MI (US)

(21) Appl. No.: 12/612,482

(22) Filed: Nov. 4, 2009

(51) Int. Cl. G06F 19/00; G01K 15/00

(52) U.S. Cl. 702/99

(57) ABSTRACT

A method for interpreting a temperature reading of a thermistor includes the steps of calculating a power dissipation of the thermistor via a processor and calculating a temperature error for the temperature reading via the processor using the power dissipation.

### TECHNICAL FIELD

The present invention generally relates to the field of thermistors and, more specifically, to methods and systems thermistor temperature processing.

### BACKGROUND

Thermistors, or thermally sensitive resistors, are often used for measuring temperature in electrical circuits, for example in engine transmissions of vehicles. Generally a small, measured direct current is passed through the thermistor, and a resulting voltage drop is measured for the thermistor. The voltage drop can then be used to estimate a temperature for the electrical circuit and/or the surrounding environment, such as the engine transmission of a vehicle.

Thermistors can be an effective tool in measuring temperatures of various environments, such as engine transmissions in vehicles. However, thermistors can engage in self-heating or self-cooling, which can result in thermistor temperature readings that vary from the true temperature of the electrical circuit and/or the surrounding environment, such as the engine transmission of a vehicle.

Accordingly, an improved method is desired for processing thermistor readings in a manner that may account for thermistor self-heating or self-cooling, and that therefore may provide a more accurate measure of the temperature of the electrical circuit and/or the surrounding environment, such as the engine transmission of a vehicle. In addition, an improved system is desired for processing thermistor readings in a manner that may account for thermistor self-heating or self-cooling, and that therefore may provide a more accurate measure of the temperature of the electrical circuit and/or the surrounding environment, such as the engine transmission of a vehicle.

Furthermore, other desirable features and characteristics of the present invention will be apparent from the subsequent detailed description and the appended claims, taken in conjunction with the accompanying drawings and the foregoing technical field and background.

### SUMMARY

In accordance with an exemplary embodiment, a method for interpreting a temperature reading of a thermistor is provided. The method comprises the steps of calculating a power dissipation of the thermistor via a processor and calculating a temperature error for the temperature reading via the processor using the power dissipation.

In accordance with another exemplary embodiment, a method for determining a temperature in a transmission system of a vehicle is provided. The method comprises the steps of measuring a voltage for a thermistor, calculating an initial temperature reading using the voltage via a processor, calculating a power dissipation of the thermistor via the processor using the voltage, calculating a temperature error for the initial temperature reading via the processor using the power dissipation, and calculating the temperature via the processor using the initial temperature reading and the temperature error.

In accordance with a further exemplary embodiment, a system for interpreting a temperature reading of a thermistor is provided. The system comprises an analog to digital converter (ADC) and a processor. The analog to digital converter (ADC) is configured to measure a voltage for the thermistor. The processor is coupled to the analog to digital converter (ADC), and is configured to calculate a power dissipation of the thermistor using the voltage and calculate a temperature error for the temperature reading using the power dissipation.

### BRIEF DESCRIPTION OF THE DRAWINGS

The present invention will hereinafter be described in conjunction with the following drawing figures, wherein like numerals denote like elements, and wherein:

FIG. 1 is a functional block diagram of a control system for processing temperature information for a thermistor of an electrical circuit, for example for an engine transmission of a vehicle, in accordance with an exemplary embodiment;

FIG. 2 is a flowchart of a process for processing temperature information for a thermistor of an electrical circuit and providing an improved measure for a temperature of an electrical circuit and/or a surrounding environment, for example for an engine transmission of a vehicle, in accordance with an exemplary embodiment;

FIG. 3 is a functional block diagram of the process of FIG. 2, as implemented in connection with a temperature-sensing circuit, including a thermistor, and that can be utilized in connection with the control system of FIG. 1, in accordance with an exemplary embodiment,

FIG. 4 is a sequence of plots showing resistance variation of a thermistor according to temperature, and that corresponds to the control system of FIG. 1 and the process of FIGS. 2 and 3, in accordance with an exemplary embodiment; and

FIG. 5 is a functional block diagram of an equivalent thermal circuit of resistance variation of a thermistor according to temperature, and that corresponds to the control system of FIG. 1 and the process of FIGS. 2 and 3, in accordance with an exemplary embodiment.

### DETAILED DESCRIPTION

The following detailed description is merely exemplary in nature and is not intended to limit the invention or the application and uses of the invention. Furthermore, there is no intention to be bound by any theory presented in the preceding background or the following detailed description.

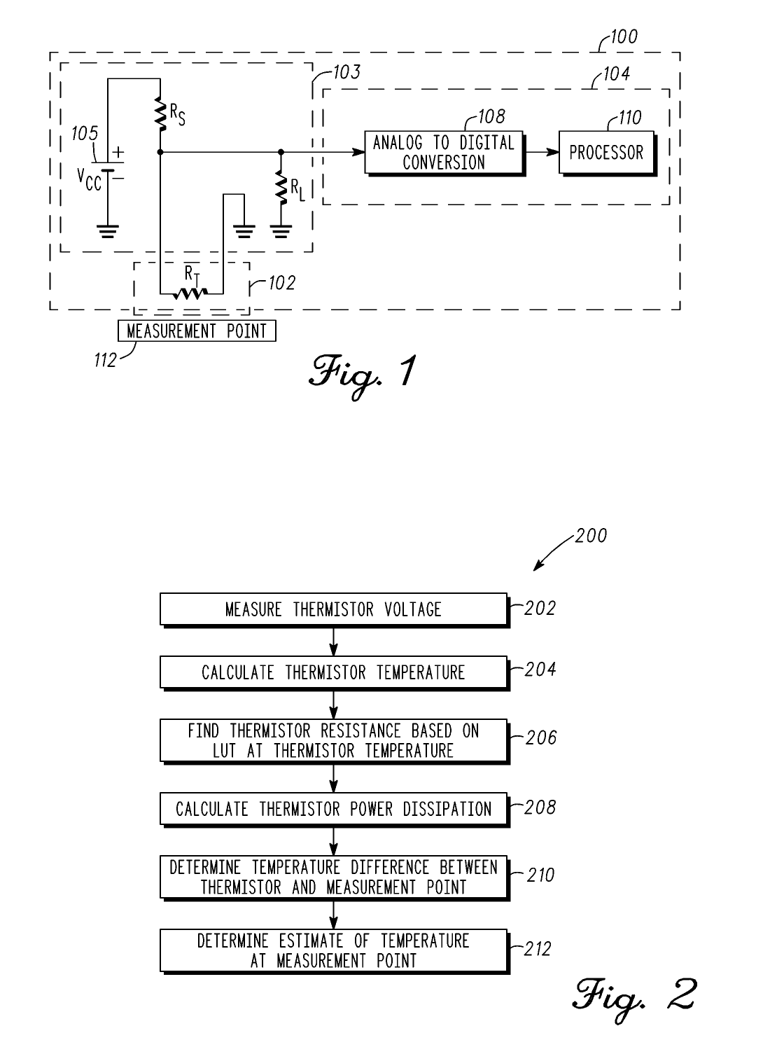

FIG. 1 is a functional block diagram of a control system 100 for processing temperature information for a thermistor 102 of an electrical circuit 103, for example for an engine transmission of a vehicle, in accordance with an exemplary embodiment. In the depicted embodiment, the thermistor 102 receives power from a power supply 105 of the electrical circuit 103. In the depicted embodiment, the thermistor 102 is coupled to the electrical circuit 103 at a measurement point 112. In one embodiment, the thermistor 102 is coupled to the electrical circuit 103 at the measurement point 112 via a cable, in order to obtain initial temperature readings for oil of a transmission of a vehicle. In addition, a corresponding thermal circuit is depicted in FIG. 5.

In the embodiment depicted in FIG. 1, the control system 100 includes a controller 104. The controller includes an analog to digital converter (ADC) 108 and a processor 110. In certain embodiments, the ADC 108 may be included as part of the processor 110, among other possible variations to the control system 100.

Also in the depicted embodiment, the ADC 108 is configured to measure the voltage of the thermistor 102 by converting the analog voltage values to digital voltage values. The ADC 108 converts such values so that these values can be read and processed by the processor 110. In a preferred embodiment, each of these functions is carried out in accordance with the steps of the process 200 set forth in FIG. 2 and described further below in connection therewith.

The processor 110 is coupled to the ADC 108, and processes the values of the voltage, among other possible digitally-converted values corresponding thereto. In so doing, the processor 110 calculates a temperature reading for the thermistor 102 along with a temperature error for this initial reading, which can then be used by the processor 110 in calculating an improved temperature reading for electrical circuit, and/or the surrounding environment, such as the engine transmission of a vehicle. In a preferred embodiment, each of these functions is carried out in accordance with the steps of the process 200 set forth in FIG. 2 and described further below in connection therewith.

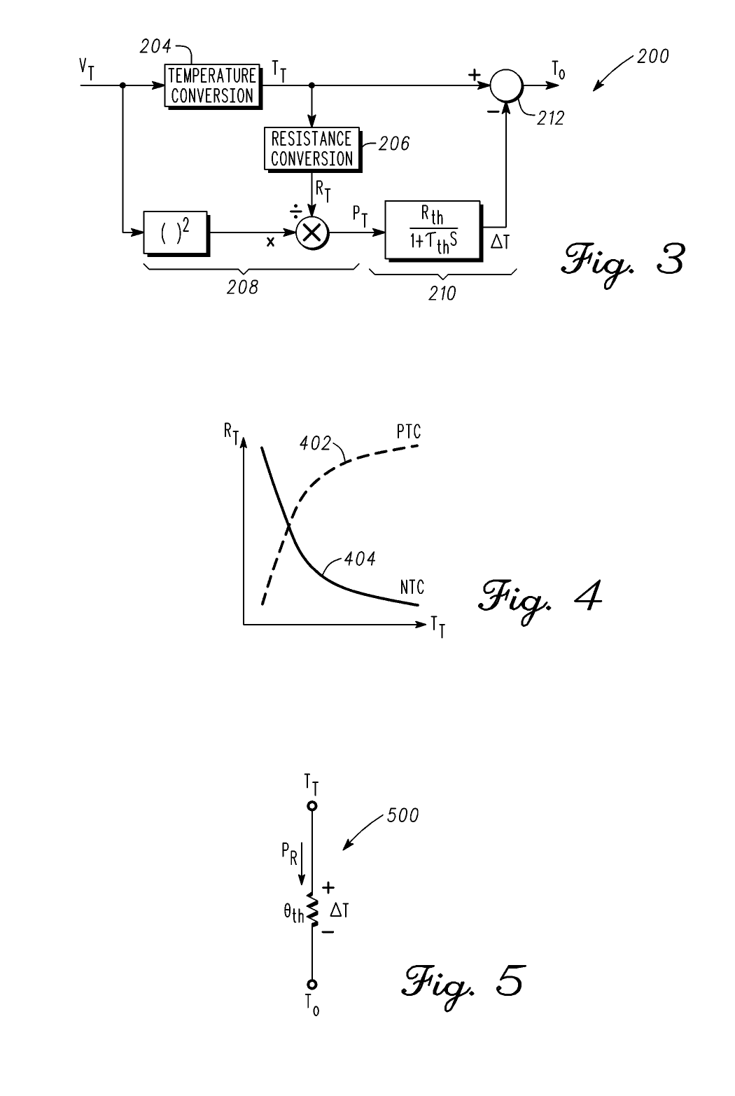

FIG. 2 is a flowchart of a process 200 for processing temperature information for a thermistor of an electrical circuit and providing an improved measure for a temperature of an electrical circuit and/or a surrounding environment, for example for an engine transmission of a vehicle, in accordance with an exemplary embodiment. The process 200 can be utilized in conjunction with the above-referenced control system 100, thermistor 102, electrical circuit 103, and controller 104 of FIG. 1, and the corresponding thermal circuit 500 of FIG. 5, also in accordance with an exemplary embodiment. In addition, a functional block diagram of the process 200 is provided in FIG. 3, which will also be referenced during the description of the process 200 below.

As depicted in FIG. 2, the process 200 includes the measuring of a thermistor voltage (V_{T}) (step 202). In a preferred embodiment, during step 202 the thermistor voltage (V_{T}) across the thermistor 102 of FIG. 1 is measured by the ADC 108 of FIG. 1 and converted from analog to digital form for processing by the processor 110 of FIG. 1. Also in a preferred embodiment, the thermistor voltage corresponds to a voltage of the thermistor 102 of FIG. 1 when the thermistor 102 is placed at the measurement point 112 of FIG. 1. In addition, in certain embodiments, a power supply voltage (V_{cc}) may also be measured (this power supply voltage V_{cc} is also depicted in the functional block diagram of FIG. 3). Also, as described above in connection with FIG. 1, in certain embodiments the ADC 108 of FIG. 1 is part of the processor 110 of FIG. 1.

A temperature reading for the thermistor is calculated (step 204). In a preferred embodiment, the initial temperature reading (T_{T}) calculated in step 204 corresponds to a temperature reading of the thermistor 102 of FIG. 1, prior to accounting for any self-heating or self-cooling of the thermistor 102. Also in a preferred embodiment, the initial temperature reading is calculated by the processor 110 of FIG. 1 using a change in voltage in the thermistor voltage V_{T} of step 202 associated with the power provided by the power supply 105 of FIG. 1 to the thermistor 102 of FIG. 1. In addition, in a preferred embodiment, the temperature reading corresponds to a temperature indicated by the thermistor 102 of FIG. 1 at the measurement point 112 of FIG. 1.

A thermistor resistance is then obtained (step 206). In a preferred embodiment, the thermistor resistance is obtained by the processor 110 using a look-up table stored in a memory of the controller 104 of FIG. 1 at the thermistor temperature value calculated in step 204. Also in a preferred embodiment, the thermistor resistance represents an electrical resistance of the thermistor 102 of FIG. 1 when the thermistor 102 is placed at the measurement point 112 of FIG. 1.

In addition, a power dissipation for the thermistor is calculated (step 208). In a preferred embodiment, the power dissipation represents a power dissipation of the thermistor 102 of FIG. 1 when the thermistor 102 is placed at the measurement point 112 of FIG. 1.

In addition, also in a preferred embodiment, the power dissipation (P_{T}) is calculated for the thermistor 102 of FIG. 1 by the processor 110 of FIG. 1 using the thermistor voltage of step 202 and the thermistor resistance of step 206. Specifically, in one preferred embodiment, the power dissipation is calculated for the thermistor 102 of FIG. 1 by the processor 110 of FIG. 1 in accordance with the following equation:

$${P}_{T} = \frac{{V}_{T}^{2}}{{R}_{T}} = {V}_{cc}^{2} \cdot \frac{{R}_{T}}{{( {R}_{S} + {R}_{T} )}^{2}} , \qquad ( Equation 1 )$$

in which P_{T} represents the power dissipation of the thermistor 102 of FIG. 1, Vₜ represents the thermistor voltage as measured in step 202, R_{T} represents the thermistor resistance calculated in step 206, V_{cc} represents the power supply voltage of the analog circuit 103 (which may be a known value or a measured value in various embodiments), and Rₛ represents the source resistor of the analog circuit 103 (which is preferably a known value). In Equation 1, a separate, post-transducer resistance value (R_{L}) (depicted in the functional block diagram of FIG. 3) is assumed to be relatively negligible in comparison with the other resistance values under applicable conditions, and thus is not included in the above-described Equation 2.

A temperature error (or temperature difference) is then calculated (step 210). In a preferred embodiment, the temperature error (or temperature difference) represents an error or difference from the temperature reading of the thermistor 102 of FIG. 1 when the thermistor 102 is placed at the measurement point 112 of FIG. 1 as compared with the actual temperature of the electrical circuit 103 and/or the surrounding environment at the measurement point 112 of FIG. 1.

In addition, also in a preferred embodiment, the temperature error is calculated for the thermistor 102 of FIG. 1 by the processor 110 of FIG. 1 using a known value of thermal impedance (for example, as provided by a manufacturer of the thermistor and/or as otherwise available, for example in a memory of the controller 104) and the power dissipation calculated in step 208. Specifically, the temperature error is calculated for the thermistor 102 of FIG. 1 by the processor 110 of FIG. 1 in accordance with the following equation:

ΔT(s)=Θₜₕ(s)·P_{T} (Equation 2),

in which ΔT(s) represents the temperature error for the thermistor and its initial temperature reading after the Laplace transformation, Θₜₕ(s) represents the thermal impedance of the thermistor after the Laplace transformation, and Pₜ represents the power dissipation of the thermistor. Also in a preferred embodiment, the temperature error ΔT represents a difference between the thermistor temperature calculated in step 204 and an actual temperature value for the electrical circuit and/or a surrounding environment, such as an engine transmission for a vehicle, due to self-heating or self-cooling of the thermistor.

A revised temperature value is then calculated (step 212). In a preferred embodiment, the revised temperature comprises an estimated temperature at the measurement point 112 of FIG. 1. Also in a preferred embodiment, the revised temperature value is calculated for the thermistor 102 of FIG. 1 by the processor 110 of FIG. 1 in accordance with the following equation:

T₀=T_{T}−ΔT (Equation 3),

in which T₀ represents the revised temperature value of step 216, T_{T} represents the thermistor temperature of step 204, and ΔT(s) represents the temperature error or temperature difference of step 210. Also in a preferred embodiment, the revised temperature value T₀ represents a more accurate or current temperature reading for the electrical circuit and/or a surrounding environment, such as an engine transmission for a vehicle, after accounting for self-heating or self-cooling of the thermistor. In certain embodiments, the revised temperature value T₀ can then be used by the processor 110 and/or by one or more control systems in adjusting and/or controlling one or more components of an engine transmission for a vehicle and/or one or more other systems and/or environments.

FIG. 4 is a sequence of plots 402, 404 showing electrical resistance variation of a thermistor according to temperature, in accordance with an exemplary embodiment. The plots 402, 404 correspond to the resistance of thermistor 102 of FIG. 1, the look-up table in 204 and 206 of FIG. 2, and the look-up table used in process 204 and 206 of FIG. 3, also in accordance with an exemplary embodiment. Depending on the characteristics of the thermistor 102 in FIG. 1, its resistance can increase of decrease as temperature increases. Specifically, FIG. 4 depicts two different characteristic curves, a positive temperature coefficient plot 402 and a negative temperature coefficient plot 404, for different thermistors.

As shown in FIG. 4, the initial temperature readings (T_{T}) of one type of thermistor 102 of FIG. 1 faces a higher positive temperature coefficient as the initial temperature readings (T_{T}) increase. Conversely, and also as shown in FIG. 4, the initial temperature readings (T_{T}) of the other type of thermistor 102 of FIG. 1 yields faces a higher negative temperature coefficient as the initial temperature readings (T_{T}) decrease. Depending on the application, any of these thermistors can be used.

In addition, in a preferred embodiment, FIG. 4 depicts the electrical characteristic (specifically, a resistance) of different exemplary types of thermistors. In a preferred embodiment, one of the plots or curves in FIG. 4 is stored in a memory of the controller 104 of FIG. 1, and the other plot or curve in FIG. 4 is used as the look-up table in steps 204 and 206 of FIG. 2.

Accordingly, a thermistor 102 of FIG. 1 having a positive temperature coefficient can be expected to have a relatively larger temperature error in step 212 of the process 200 of FIG. 2 at relatively higher temperatures. Under such conditions for a thermistor 102 of FIG. 1 having a positive temperature coefficient, the control system 100 and controller 104 of FIG. 1 and the process 200 of FIG. 2 are particularly effective at improving upon the initial temperature reading provided by the thermistor 102 of FIG. 1 having a positive temperature coefficient.

Likewise, a thermistor 102 of FIG. 1 having a negative temperature coefficient can be expected to have a relatively larger temperature error in step 214 of the process 200 of FIG. 2 at relatively lower temperatures. Under such conditions for a thermistor 102 of FIG. 1 having a negative temperature coefficient, the control system 100 and controller 104 of FIG. 1 and the process 200 of FIG. 2 are particularly effective at improving upon the initial temperature reading provided by the thermistor 102 of FIG. 1 having a positive temperature coefficient.

The disclosed methods and systems provide for improved processing of thermistor temperature values. For example, the disclosed methods and systems help to correct for self-heating or self-cooling of thermistors, to thereby identify and correct any resulting temperature errors in thermistor temperature readings as a result of such self-heating or self-cooling. The disclosed methods and systems can similarly be used to more accurately measure or predict temperature values for the thermistor, a corresponding electrical circuit, and/or a surrounding environment, such as an engine transmission for a vehicle.

It will be appreciated that the disclosed method and systems may vary from those depicted in the Figures and described herein. For example, as mentioned above, certain elements of the control system 100 and/or the controller 104 of FIG. 1, and/or portions and/or components thereof, may vary, and/or may be part of and/or coupled to one another and/or to one or more other systems and/or devices. In addition, it will be appreciated that certain steps of the process 200 may vary from those depicted in FIG. 2 and/or described herein in connection therewith, and/or may be performed simultaneously and/or in a different order than that depicted in FIG. 2 and/or described herein in connection therewith. It will similarly be appreciated that the disclosed methods and systems may be implemented and/or utilized in connection with various different types of vehicles and/or other devices.

While at least one exemplary embodiment has been presented in the foregoing detailed description, it should be appreciated that a vast number of variations exist. It should also be appreciated that the exemplary embodiment or exemplary embodiments are only examples, and are not intended to limit the scope, applicability, or configuration of the invention in any way. Rather, the foregoing detailed description will provide those skilled in the art with a convenient road map for implementing the exemplary embodiment or exemplary embodiments. It should be understood that various changes can be made in the function and arrangement of elements without departing from the scope of the invention as set forth in the appended claims and the legal equivalents thereof.

We claim:

1. A method for interpreting a temperature reading of a thermistor, the method comprising the steps of:
calculating a power dissipation of the thermistor via a processor; and
calculating a temperature error for the temperature reading via the processor using the power dissipation.

2. The method of claim 1, further comprising the step of:
calculating a revised temperature value via the processor using the temperature reading and the temperature error.

3. The method of claim 2, wherein the step of calculating the revised temperature value comprises the step of subtracting the temperature error from the temperature reading via the processor, to thereby calculate the revised temperature value.

4. The method of claim 1, further comprising the step of:
determining a resistance for the thermistor via the processor, wherein the step of calculating the temperature error comprises the step of calculating the temperature via the processor using the resistance and the power dissipation.

5. The method of claim 4, wherein the step of determining the resistance comprises the step of determining the resistance using a look-up table and the temperature reading via the processor.

6. The method of claim 3, further comprising the steps of:
measuring a voltage of the thermistor; and
calculating the temperature reading via the processor using the voltage.

7. The method of claim 6, wherein the step of measuring the voltage comprises the step of measuring the voltage using an analog to digital converter (ADC).

8. The method of claim 2, wherein:
the step of calculating the temperature error comprises the step of calculating the temperature error at a measuring point via the processor; and
the step of calculating the revised temperature value comprises the step of calculating the revised temperature value at the measuring point via the processor.

9. A method for determining a temperature in a transmission system of a vehicle, the method comprising the steps of:
measuring a voltage for a thermistor;
calculating an initial temperature reading using the voltage via a processor;
calculating a power dissipation of the thermistor via the processor using the voltage;
calculating a temperature error for the initial temperature reading via the processor using the power dissipation; and
calculating the temperature via the processor using the initial temperature reading and the temperature error.

10. The method of claim 9, the step of calculating the temperature comprises the step of subtracting the temperature error from the initial temperature reading via the processor, to thereby calculate the temperature.

11. The method of claim 9, further comprising the step of:
determining a resistance for the thermistor, wherein the step of calculating the temperature error comprises the step of calculating the temperature via the processor using the resistance and the power dissipation.

12. The method of claim 11, wherein the step of determining the resistance comprises the step of determining the resistance using a look-up table and the initial temperature reading via the processor.

13. The method of claim 9, wherein:
the step of calculating the temperature error comprises the step of calculating the temperature error at a measuring point via the processor; and
the step of calculating the temperature value comprises the step of calculating the revised temperature value at the measuring point via the processor.

14. The method of claim 9, wherein the step of measuring the voltage comprises the step of measuring the voltage using an analog to digital converter (ADC).

15. A system for interpreting a temperature reading of a thermistor, the system comprising:
an analog to digital converter (ADC) configured to measure a voltage for the thermistor; and
a processor coupled to the analog to digital converter (ADC), the processor configured to:
calculate a power dissipation of the thermistor using the voltage; and
calculate a temperature error for the temperature reading using the power dissipation.

16. The system of claim 15, wherein the processor is further configured to calculate a revised temperature value using the temperature reading and the temperature error.

17. The system of claim 16, wherein the processor is further configured to subtract the temperature error from the temperature reading via the processor, to thereby calculate the revised temperature value.

18. The system of claim 15, wherein the process is further configured to:
determine a resistance of the thermistor; and
calculate the power dissipation using the voltage and the resistance.

19. The system of claim 18, wherein the processor is further configured to determine the resistance using a look-up table and the temperature reading via the processor.

20. The system of claim 19, wherein the processor is further configured to:
calculate the temperature error at a measuring point; and
calculate the revised temperature value at the measuring point.
